(19) United States
(12) Patent Application Publication
(10) Pub. No.: US 2015/0356589 A1
(43) Pub. Date: Dec. 10, 2015

(54) COUPON MANAGEMENT FOR DIGITAL CONTENT SUBSCRIBERS

(71) Applicant: Verizon Patent and Licensing Inc., Arlington, VA (US)

(72) Inventors: Zhiying Jin, Lexington, MA (US); Seldron D. Geziben, Wayland, MA (US)

(21) Appl. No.: 14/297,757

(22) Filed: Jun. 6, 2014

(51) Int. Cl. G06Q 30/02

(52) U.S. Cl. CPC G06Q 30/0224; G06Q 30/0239

(57) ABSTRACT

Data regarding actions taken by a user, such as purchasing and bookmarking content from different digital content types, is acquired and processed to determine a digital coupon that can be used by the user when accessing additional content. Determining the coupon may include selecting a particular digital content type and a benefit based on the actions. For example, scores for the digital content types may be determined based on the actions, and the particular digital content type and the benefit may be determined based on the scores. The digital coupon may be directly provided to the user (e.g., sent to the user's set-top box) or to a third party, such as an operator of a kiosk distributing physical media.

### BACKGROUND

A service provider may offer a broad range of multimedia services and products to subscribers. For example, the service provider may enable subscribers to use a set-top box (STB) or other user device to select among available services and products. The STB may use Internet Protocol Television (IPTV) technology to provide streamed (or live) stations or other distributed digital content, video on demand (VOD) digital content that subscribers may rent (e.g., view a limited number of times and/or for a limited time period), VOD digital content that subscribers may purchase, and/or over-the-top (OTT) content; and to arrange for distribution of physical content (such as DVDs, Blu-ray discs, memory cards, etc.) to the subscriber. For example, a subscriber may order physical content to be acquired at a kiosk.

### BRIEF DESCRIPTION OF THE DRAWINGS

FIG. 1 is a diagram illustrating concepts described herein;

FIG. 2 shows is an exemplary environment in which systems and/or methods described herein may be implemented;

FIG. 3 is a block diagram of exemplary components of a device that may correspond to any one of the devices included in the environment shown in FIG. 2;

FIG. 4 is a diagram of exemplary communication interfaces within a portion of the environment shown in FIG. 2;

FIG. 5 is a diagram of exemplary functional components of an coupon manager included in the environment shown in FIG. 2;

FIG. 6 is a diagram of exemplary functional components of an application server of the environment shown in FIG. 2;

FIG. 7 is a diagram of exemplary functional components of a billing server of the environment shown in FIG. 2; and

FIG. 8 is a flow chart of an exemplary process for providing access to multi-screen video and physical asset orders according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may relate to acquiring data regarding actions taken by a user, such as purchasing and bookmarking content from different digital content types. This data is processed to determine a digital coupon that can be used by the user when accessing additional content. Determining the coupon may include selecting a particular digital content type and a benefit based on the actions. For example, scores for the digital content types may be determined based on the actions, and the particular digital content type and the benefit may be determined based on the scores. The digital coupon may be directly provided to the user (e.g., sent to the user's set-top box) or to a third party, such as an operator of a kiosk distributing physical media.

As used herein, a “user device” is intended to be broadly interpreted to include a device, a user associated with the device, and/or the subscriber associated with services received via the user device. Furthermore, as used herein, a “coupon” is intended to be broadly interpreted to include a digital code that may be used by a subscriber and/or a subscriber in connection with accessing digital content.

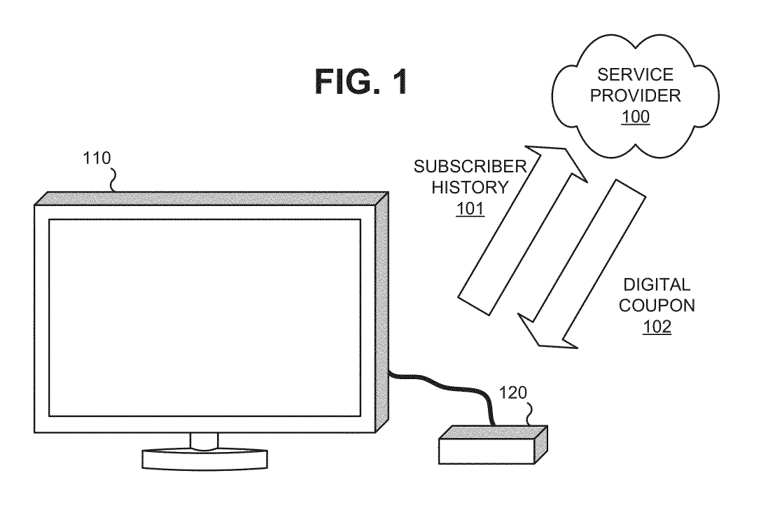

FIG. 1 is a diagram illustrating concepts described herein. As shown in FIG. 1, a service provider 100 (shown as a network cloud because the service is provided via such a network) may provide digital content to a television 110 (or other user device) based on a subscriber's selections. In some implementations, the television content may be processed through a set-top box (STB) 120 (sometimes referred to as a media client) that enables television 110 set to receive and decode television signals from service provider 100 and provides an interface that enables the subscriber to communicate with service provider 100. The interface may further allow the subscriber to perform various actions, such as viewing a catalog of available digital content, selecting digital content to be viewed, requesting additional information regarding digital content, bookmarking (e.g., storing identifying information) particular digital content, requesting delivery of physical media, etc. STB 120 may forward subscriber history 101 to service provider 100, and service provider 100 may forward a digital coupon 102 to STB 120. Subscriber history 101 may identify actions by the subscriber, such as identifying inputs received via the interface related to viewing a catalog of available digital content, selecting digital content to be viewed, requesting additional information regarding digital content, bookmarking digital content, requesting delivery of physical media, etc. Digital coupon 102 may enable a subscriber to access a particular type of service via STB 120 at a reduced (or no) cost and/or alter defined conditions, such as to change times when content is available, change a format of the content, and/or change users devices that may access the requested products/services.

In certain implementations, service provider 100 may determine a particular type of service or product associated with digital coupon 102 based on subscriber history 101. Service provider 100 may review subscriber history 101 to identify a particular service or product that is infrequently used (e.g., less than a threshold number of times and/or less than a threshold percentage of total use) by the subscriber. In this way, digital coupon 102 may be offered to encourage the subscriber to try a different service and/or product that is not typically used by the subscriber. For example, if the subscriber tends to view streamed content (e.g., content that is provided for free or in connection with a subscription) but does not order VOD content, digital coupon 102 may offer discounted access to the VOD content.

In another example, service provider 100 may review subscriber history 101 to identify a particular service or product in which the subscriber appears to have an interest. For example, service provider 100 may determine that the subscriber has an interest in particular content when the customer accesses information regarding the particular content in the catalog, adds the particular content to a digital shopping cart, and/or bookmarks the particular content.

Service provider 100 may further determine a discount amount associated with digital coupon 102 based on subscriber history 101. For instance, the discount amount may be determined based on the subscriber's actions through STB 120. For example, the discount amount may be determined based on actions related to the services or products, such as the subscriber's usage history, the number of times that the subscriber has accessed related information in the digital catalog, the number of times the subscriber has bookmarked different types of digital contents, etc. In this way, service provider 100 may determine a discount amount based on potential interests of the subscriber.

In addition or alternatively, service provider 100 may determine the discount amount associated with digital coupon 102 based on the subscriber's use of prior coupons. Service provider 100 may increase, decrease, or maintain the discount associated with a prior coupon based on whether the subscriber used the prior coupon. For example, a discount associated with the prior coupon may be increased if the subscriber does not use the prior coupon.

In another implementation, digital coupon 102 may provide the subscriber with a non-monetary benefit, such as to modify terms of use related to accessing the digital contents. For example, digital coupon 102 may increase an amount of time that a subscriber is authorized to access a digital content, enable the subscriber to access the digital content using a different user device, increase the number of times that the subscriber may access the digital content, etc.

Service provider 100 may also provide a distribution service for digital coupons. For example, service provider 100 may provide a digital coupon to a third party (not shown) who distributes digital coupon 102 to the subscriber via STB 120 or another user device associated with the subscriber. For example, if the third party is associated with distributing physical media via a kiosk, the third party may receive and apply digital coupon 102 when the subscriber attempts to obtain physical media using the kiosk.

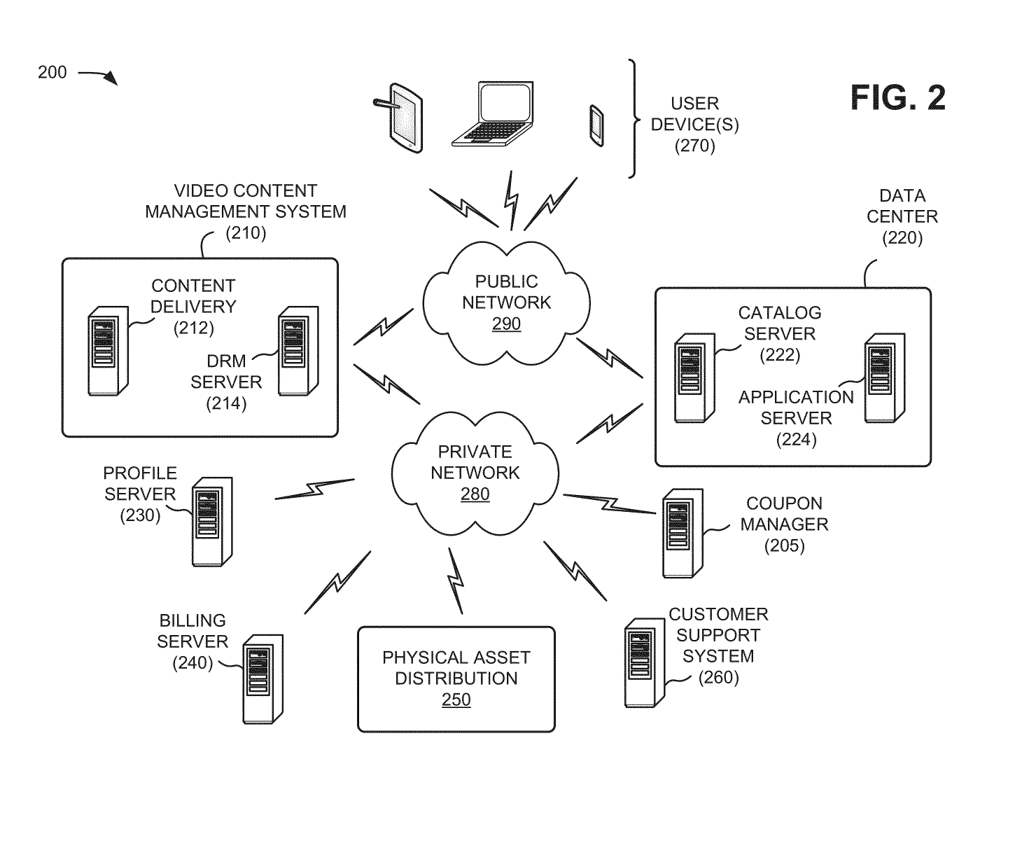

FIG. 2 shows an exemplary environment 200 in which systems and/or methods described herein may be implemented. One or more components of environment 200 may be associated with service provider 100. As illustrated in FIG. 2, environment 200 may include a coupon manager 205, a video content management system (VCMS) 210, a data center 220, a profile server 230, a billing server 240, a physical asset distribution system 250, a customer support system 260, user devices 270, a private network 280, and a public network 290. The particular arrangement and number of components of environment 200 shown in FIG. 2 are illustrated for simplicity. In practice there may be more coupon managers 205, VCMSs 210, data centers 220, profile servers 230, billing servers 240, physical asset distribution systems 250, customer support systems 260, user devices 270, and/or networks 280/190. Components of environment 200 may be connected via wired and/or wireless links.

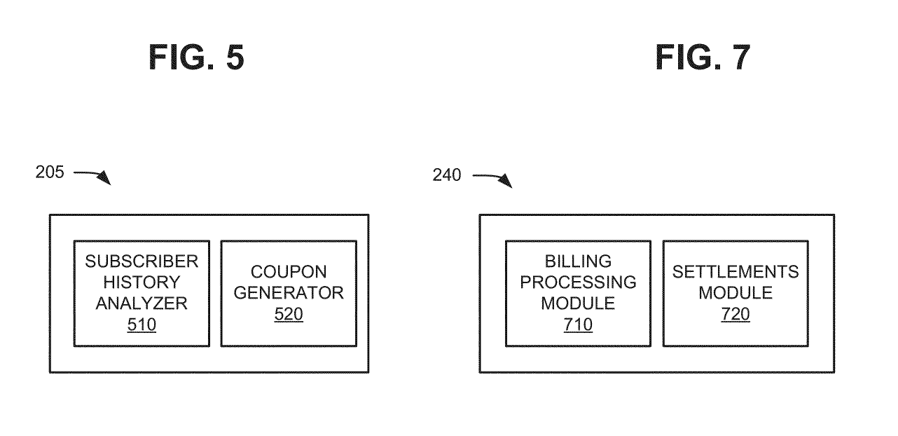

As described in greater detail below with respect to FIG. 5, coupon manager 205 may collect information regarding subscriber history 101 and may use this information to generate digital coupon 102. For example, coupon manager 205 may interact with one or more components of environment 200 to determine subscriber history 101.

VCMS 210 may include one or more network devices, or other types of computation or communication devices, to aggregate content and content metadata, process content, and distribute content. In one implementation, VCMS 210 may include a content delivery system 212 and a digital rights management (DRM) server 214. VCMS 210 may aggregate content and transcode content into a digital format suitable for consumption on particular user devices 270. For example, VCMS 210 may include a transcoding device to convert a video file from one format to another (e.g., from one bit rate to another bit rate, from one resolution to another, from one standard to another, from one file size to another, etc). VCMS 210 may also encrypt data and communicate with DRM server 214 to enforce digital rights.

Content delivery system 212 may include one or more network devices, or other types of computation or communication devices, to deliver digital content from a backend server to user devices 270. In one implementation, content delivery system 212 may include a streaming server that provides streaming data packets (e.g., via a streaming URL) to user devices 270 (e.g., via network 280). In one implementation, a streaming URL may be session-based, such that each URL can be used only once for one user device 270 for security purposes.

DRM server 214 may include one or more network devices, or other types of computation or communication devices, to issue, validate, and/or enforce DRM licenses to a client, such as an application running on one of user devices 270. In implementations herein, DRM server 214 may communicate with user device 270 to authenticate a subscriber of user device 270, the particular user device 270, and/or an application residing on user device 270. For example, DRM server 214 may request/receive login information associated with the subscriber, and compare the login information with stored information to authenticate the subscriber. Additionally, or alternatively, DRM server 214 may request/receive device information (e.g., a unique device identifier) associated with user device 270, and may compare the device information with stored information to authenticate user device 270.

Data center 220 may include one or more network devices, or other types of computation or communication devices, to manage the authorization, selection, and/or purchase of multimedia content by a subscriber of user devices 270. As shown in FIG. 2, data center 220 may include a catalog server 222 and an application server 224. In one implementation, data center 220 may be accessed by user devices 270 via public network 290.

Catalog server 222 may include one or more network devices, or other types of computation or communication devices, to provide a catalog of both digital and physical content for subscribers (e.g., of user devices 270) to consume (e.g., buy, rent, or subscribe). In one implementation, catalog server 222 may collect and/or present listings of content available to user devices 270. For example, catalog server 222 may receive digital and/or physical content metadata, such as lists or categories of content, from VCMS 210 and/or physical asset distribution system 250. Catalog server 222 may use the content metadata to provide currently-available content options to user devices 270. Catalog server 222 may provide the content metadata to user device 270 directly or may communicate with user device 270 via application server 224.

Application server 224 may include one or more network devices, or other types of computation or communication devices (e.g., a server device, an application server device, a Web server device, a database server device, a computer, etc.), to provide a backend support system for mobile applications residing on user devices 270. For example, application server 224 may permit user device 270 to download a video application that may permit a subscriber to find content of interest or play downloaded or streaming content. The video application may enable user device 270 to present to a subscriber of user device 270 information received from data center 220 in an interactive format to allow selection of particular digital or physical content. Additionally, or alternatively, application server 224 may provide content metadata, such as lists or categories of content. Also, application server 224 may authenticate a subscriber who desires to purchase, rent, or subscribe to digital or physical content. In one implementation, the interactions between application server 224 and user device 270 may be performed using hypertext transfer protocol (HTTP) or secure HTTP (HTTPS) via public network 290.

Profile server 230 may include one or more network devices, or other types of computation or communication devices, to store subscriber profile information for subscribers (e.g., subscribers of user devices 270). The subscriber profile information may include various information regarding a subscriber, such as login information (e.g., a subscriber identifier and a password), billing information, address information, types of services to which the subscriber has subscribed, a list of digital/physical content purchased by the subscriber, a list of video content rented by the subscriber, a list of video content to which the subscriber has subscribed, a user device identifier (e.g., a media player identifier, a mobile device identifier, a set top box identifier, a personal computer identifier) for user device 270, a video application identifier associated with the video application obtained from application server 224, or the like. Application server 224 may use the subscriber profile information from profile server 230 to authenticate a subscriber and may update the subscriber profile information based on the subscriber's activity (e.g., with a subscriber's express permission).

Billing server 240 may include one or more network devices, or other types of computation or communication devices, to manage charging subscribers for services provided via environment 200. Billing server 240 may include, for example, a payment processing component, a billing component, and/or a settlement component.

Physical asset distribution system 250 may include one or more network devices, or other types of computation or communication devices, to track availability of physical content (e.g., DVDs, Blu-ray discs, memory cards, etc.) and provide metadata of physical content for inclusion in catalog information provided to subscribers of user devices 270. In one implementation, physical asset distribution system 250 may also provide physical assets information, such as location information, so that when a subscriber wants to buy a physical asset, the system can direct the subscriber to the nearest geographic location (e.g., to retrieve the physical asset). Additionally, or alternatively, physical asset distribution system 250 may generate or receive credit information for subscribers (e.g., for cross-promotion purposes). For example, after a subscriber of user device 270 has purchased a digital asset or subscription/rental, the subscriber may be entitled some credits for getting a physical asset or vice versa. In implementations described herein, physical asset distribution system 250 may be controlled by a different entity (e.g., a third-party provider) than the entity controlling VCMS 210, datacenter 220, and/or other components of environment 200.

Customer support system 260 may include one or more network devices, or other types of computation or communication devices, to solicit and/or receive subscriber feedback, questions, or credit-related requests. In one implementation customer support system 260 may include interfaces with data center 220 and/or billing server 240, for example, to receive problem reports and to resolve customer billing disputes.

User device 270 may include a computation or communication device to enable a subscriber to view video content or interact with another user device 270 or a video display device (e.g., a set-top box and/or television). User device 270 may include, for example, a personal communications system (PCS) terminal (e.g., a smartphone that may combine a cellular radiotelephone with data processing and data communications capabilities), a tablet computer, a smartphone, a personal computer, a laptop computer, a gaming console, an Internet television, or other types of computation or communication devices. In one implementation, user device 270 may include a client-side application that enables user device 270 to communicate with, for example, data center 220 and/or present information received from data center 220 to a subscriber. The client-side application may permit a subscriber of user device 270 to log into an account (e.g., via application server 224), access catalog information (e.g., from catalog server 222), submit an order, and/or consume live streaming video content (e.g., from VCMS 210).

Private network 280 may include, for example, one or more private IP networks that use a private IP address space. Private network 280 may include a local area network (LAN), an intranet, a private wide area network (WAN), etc. In one implementation, private network 280 may implement one or more Virtual Private Networks (VPNs) for providing communication between, for example, any of VCMS 210, data center 220, profile server 230, billing server 240, physical asset distribution system 250, and/or customer support system 260. Private network 280 may be protected/separated from other networks, such as public network 290, by a firewall. Although shown as a single element in FIG. 2, private network 280 may include a number of separate networks.

Public network 290 may include a local area network (LAN), a wide area network (WAN), such as a cellular network, a satellite network, a fiber optic network, a private WAN, or a combination of the Internet and a private WAN, etc. that is used to transport data. Although shown as a single element in FIG. 2, public network 290 may include a number of separate networks that provide services to user devices 270.

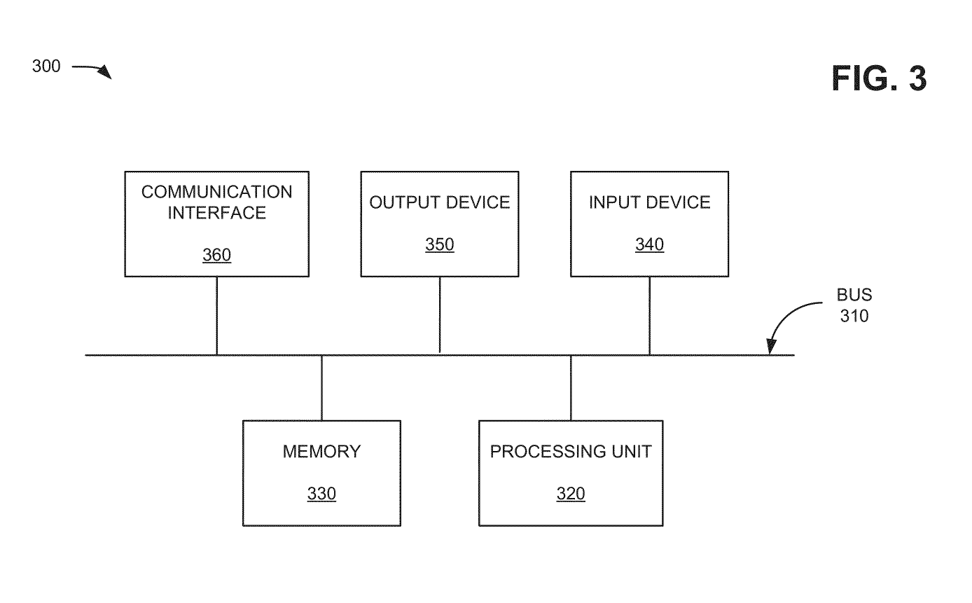

FIG. 3 is a diagram of exemplary components of a device 300 that may correspond to one or more of coupon manager 205, VCMS 210, content delivery system 212, DRM server 214, data center 220, catalog server 222, application server 224, profile server 230, billing server 240, physical asset distribution system 250, customer support system 260, or user device 270. Each of coupon manager 205, VCMS 210, content delivery system 212, DRM server 214, data center 220, catalog server 222, application server 224, profile server 230, billing server 240, physical asset distribution system 250, customer support system 260, and user device 270 may include one or more devices 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processing unit 320, a read only memory (ROM) or another type of static storage device that stores static information and instructions for the processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, one or more biometric mechanisms, and the like. Output device 350 may include a device that outputs information to the operator, such as a display, a speaker, etc.

Communication interface 360 may include any transceiver-like mechanism that enables device 300 to communicate with other devices and/or systems. For example, communication interface 360 may include mechanisms for communicating with other devices, such as other devices of environment 200.

As described herein, device 300 may perform certain operations in response to processing unit 320 executing software instructions contained in a computer-readable medium, such as memory 330. A computer-readable medium may include a non-transitory memory device. A memory device may include a single physical memory device or may be spread across multiple physical memory devices. The software instructions may be read into memory 330 from another computer-readable medium or from another device via communication interface 350. The software instructions contained in memory 330 may cause processing unit 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than those depicted in FIG. 3. As an example, in some implementations, input device 340 and/or output device 350 may not be implemented by device 300. In these situations, device 300 may be a “headless” device that does not explicitly include an input or an output device. Alternatively, or additionally, one or more components of device 300 may perform one or more other tasks described as being performed by one or more other components of device 300.

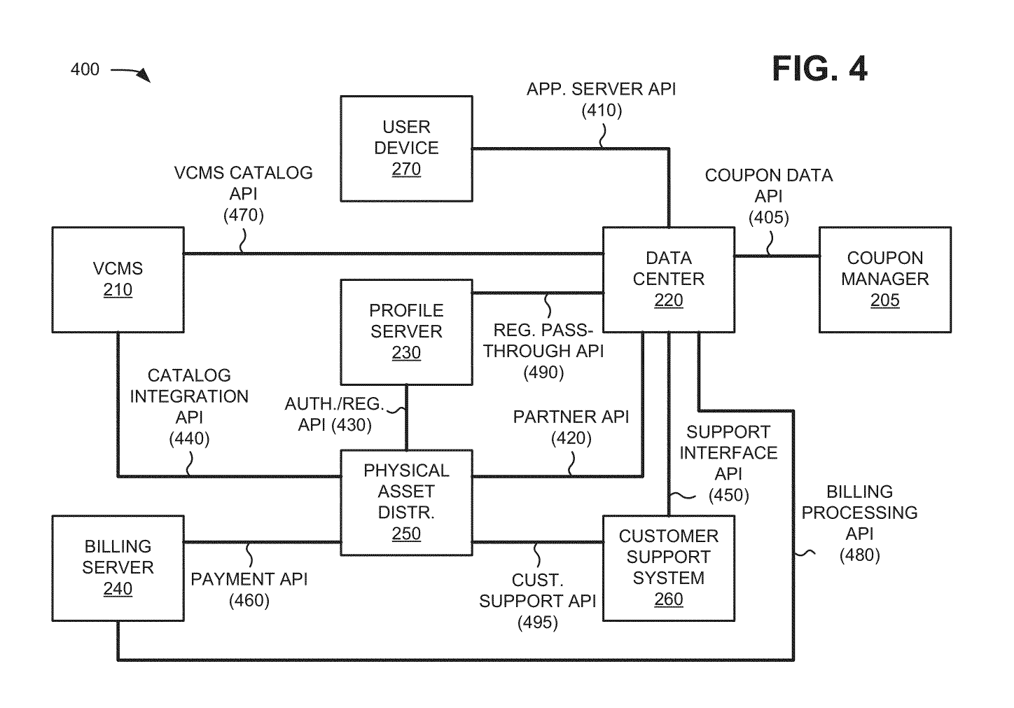

FIG. 4 is a diagram of exemplary communication interfaces for a portion 400 of environment 200. Communication interfaces in FIG. 4 may represent communications to support collecting subscriber history 101 and determining digital coupon 102 by coupon manager 205. As shown in FIG. 4, network portion 400 may include coupon manager 205, VCMS 210, data center 220, profile server 230, billing server 240, physical asset distribution system 250, customer support system 260, and user device 270.

Network portion 400 may include coupon data application programming interface (API) 405, application server API 410, a partner API 420, an authentication and registration API 430, a catalog integration API 440, a support interface 450, a payment gateway API 460, a VCMS catalog API 470, a billing processing API 480, a registration pass-through API 490, and a customer support API 495. The interfaces of network portion 400 may be standard APIs, such as Web Service APIs, such that components (e.g., such as another physical asset distribution system 250, or other third-party systems) may be plugged in or exchanged into the existing architecture of environment 200.

Data center 220 may provide coupon data API 405 to provide subscriber history 101 to coupon manager 205, and may receive digital coupon 102 from coupon manager 205 via coupon data API 405. As described in greater detail below, data center 220 may collect subscriber history 101 via one or more of application server API 410, partner API 420, authentication and registration API 430, catalog integration API 440, support interface 450, payment gateway API 460, VCMS catalog API 470, billing processing API 480, registration pass-through API 490, or customer support API 495.

Data center 220 may provide application server API 410 to user device 270. Data center 220 (e.g., application server 224) may provide different APIs to user device 270 depending on, for example, the type of operating system included on user device 270. For example, application server API 410 may include a web (e.g., web 2.0) API, an Android® API, an iOS API, or a Windows CE API (not shown). Application server API 410 may enable user device 270 to view, search, and/or place orders from catalogs provided by data center 220; bookmark digital content maintained by data center 220; etc. Data center 220 may further provide digital coupon 102 (received from coupon manager 205 via coupon API 405) to user device 270 via application server API 410.

Data center 220 may provide partner API 420 to physical asset distribution system 250. Partner API 420 may include, for example, an interface to identify/update physical asset locations, conduct authentication and registrations in third-party systems (e.g., associated with physical asset distribution system 250), and/or exchange credit/discount information for subscriber accounts (e.g., for cross-promotion purposes).

Profile server 230 may provide an authentication and registration API 430 to physical asset distribution system 250. Authentication and registration API 430 may permit profile server 230 to register new subscribers with physical asset distribution system 250 or to initiate subscriber authentication procedures for physical asset distribution system 250. In the case of new subscriber registrations, profile server 230 may collect subscriber information from user device 270 (e.g., via application server 224 in data center 220) and provide the subscriber information to physical asset distribution system 250 to create an account in a physical asset distribution system 250 database. In the case of authentications of existing subscriber accounts, profile server 230 may collect subscriber login information (e.g., a login name and password) from user device 270 (e.g., via application server 224 in data center 220) and provide the login information to physical asset distribution system 250 for authentication. Assuming the subscriber is authenticated by physical asset distribution system 250, profile server 230 may generate a session token with a particular expiration time and send the session token to user device 270 (e.g., via application server 224 in data center 220) for future validation.

Physical asset distribution system 250 may implement catalog integration API 440 to inform VCMS 210 of physical assets available to subscribers of user devices 270. Physical asset distribution system 250 may use catalog integration API 440 to provide catalog descriptions for physical media assets and/or metadata about content on the physical assets, such as titles, formats (e.g., DVD, Blu-ray, memory card, etc.), and descriptions. In one implementation, catalog integration API 440 may support delivery of an XML metadata file to VCMS 210.

Customer support system 260 may provide a support interface 450 to data center 220. Support interface 450 may include APIs to enable communications with customer support system 260. For example, support interface 450 may provide an avenue to report customer disputes (e.g., originating from user devices 270) from data center 220 to customer support system 260.

Billing server 240 may provide payment gateway API 460 for physical asset distribution system 250. Payment gateway API 460 may carry data regarding applying charges (e.g., credit card payments) to a subscriber's account in physical asset distribution system 250 for physical content ordered via data center 220. Billing server 240 may also generate internal billing entries for digital content ordered by subscribers and delivered via VCMS 210.

VCMS 210 may include VCMS catalog API 470 to export content metadata to data center 220. For example, VCMS 210 may combine information regarding available digital content (e.g., stored within VCMS 210) and catalog integration information received via catalog integration API 440 into a catalog file. VCMS 210 may provide the catalog file to data center 220 using VCMS catalog API 470.

Data center 220 may provide billing processing information to billing server 240 via billing processing API 480. Billing processing information may include, for example, identification of and/or charges associated with content ordered by subscribers of user devices 270. Billing processing API 480 may be used to support customer billing processes (e.g., for digital content) and fulfill payment transactions (e.g., for physical content).

Registration pass-through API 490 may provide a communication interface for data center 220 to exchange subscriber registration and authentication information with profile server 230. Registration information may include, for example, subscriber information (e.g., name, address, device identifiers, etc.) used to create an account for a subscriber of user device 270. Authentication information may include, for example, information (e.g., a login name and password) to access a subscriber's existing account. Data center 220 may pass registration/authentication information received from user device 270 to profile server 230, and profile server 230 may return validations to data center 220, via registration pass-through API 490.

Customer support API 495 may provide a communication interface to exchange information to resolve customer disputes. For example, customer support API may enable customer support system 260 to submit dispute information to and retrieve account information from physical asset distribution system 250.

Although FIG. 4 shows exemplary interfaces between components of network portion 400, in other implementations, network portion 400 may include fewer interfaces, different interfaces, differently arranged interfaces, or additional interfaces than those depicted in FIG. 4. Alternatively, or additionally, one or more interfaces of network portion 400 may perform one or more other tasks described as being performed by one or more other interfaces of network portion 400.

FIG. 5 is a diagram of exemplary functional components of coupon manager 205. In one implementation, the functions described in connection with FIG. 5 may be performed by one or more components of device 300 (FIG. 3). As shown in FIG. 5, coupon manager 205 may include subscriber history analyzer 510 and coupon generator 520.

Subscriber history analyzer 510 may analyze subscriber history 101 to identify actions taken by the subscriber and types of digital content associated with the actions. For example, subscriber history analyzer 510 may interface with data center 220 to identify VOD content purchased by the subscriber, VOD content rented by the subscriber, digital content items bookmarked by the subscriber, digital content viewed by the subscriber, physical media ordered by the subscriber through physical asset distribution 250, etc. In another example, subscriber history analyzer 510 may identify digital contents that a subscriber has researched, such as identifying portions of a catalog (e.g., provided by VCMS 210) that are accessed by the subscriber, searches performed by the subscriber related to digital content, previews viewed by the subscriber, content reviews read by the subscriber, etc.

Coupon generator 520 may determine a digital content type (e.g., physical media, VOD rental content, VOD purchased content, OTT content, subscription content, etc.) to associate with digital coupon 102 based on purchases, bookmarks, research, and/or other aspects of subscriber history 101. In one example, if the subscriber does not access a threshold quantity of a first type of digital content, coupon generator 520 may generate digital coupon 102 that provides an incentive for the subscriber to access the first type of digital content. In addition or alternatively, coupon generator 520 may further generate digital coupon 102 directed to the first type of digital content based on a comparison of the subscriber's activities, such as determining if the subscriber does not access a second, different type of digital content at least a threshold number of times. In another example, digital coupon 102 may be directed to the first type of digital content if the subscriber performs actions indicating an interest in the first type of digital content (e.g., bookmarking programs included in the first type of digital content, researching the programs included in the first type of digital content, and/or adding programs included in the first type of digital content to a shopping cart) without purchasing/accessing the first type of digital content.

In one implementation, coupon generator 520 may apply one or more logical rules to determine whether to generate digital coupon 102 directed to a digital content type. For example, coupon generator 520 may generate digital coupon 102 for a digital content type if the subscriber performs at least a threshold quantity of actions related to the digital content type (e.g., the subscriber purchases/rents more than a threshold quantity of titles in the digital content type). In another example, coupon generator 520 may generate digital coupon 102 for the digital content type if the subscriber's actions related to the digital content type differs from actions for another digital content type by at least a threshold amount (e.g., the subscriber accesses at least a threshold quantity more of titles in a first digital content type than titles in a second digital content type). In yet another example, coupon generator 520 may generate digital coupon 102 for the digital content type if a quantity of actions related to the digital content type, performed by the subscriber, changes by more than a threshold amount between two time periods (e.g., the subscriber accesses titles in the digital content type during a first time period at least a threshold quantity fewer times than the subscriber accesses titles in the digital content type during a second time period).

Coupon generator 520 may also determine to generate digital coupon 102 for a digital content type based on the detected subscriber activities and other factors. For example, coupon generator 520 may determine to generate digital coupon 102 for a digital content type if any technical or services concerns are identified with respect to the subscriber's access to the digital content type. For example, digital coupon 102 may allow the subscriber to access VOD content (normally available only during an initial time period) during an additional time period if the subscriber does not access the VOD content during the initial time period.

In one implementation, coupon generator 520 may determine a score for a digital content type (e.g., physical media, VOD content, OTT content, or subscription content) based on the subscriber's activities and may determine, based on the score, whether to generate digital coupon 102 for the digital content type. For example, the score may be based on the subscriber's purchases, bookmarking, researching, etc. of a digital content type. In one implementation, the score for a digital content type (Score_{type}) may be determined by summing, for each activity (i), weights (w) associated with the activity performed a number (n) of times, as represented in the following equation 1.

Score_{type}=Σnᵢ*wᵢ (Eq. 1)

For example, if the subscriber has purchased five (5) VOD titles during a time period and the weight for purchasing a VOD title is one (1), the score for VOD content is 5*1, or 5. Continuing with this example, if the subscriber also bookmarked ten (10) and the weight for bookmarking a VOD title is 0.1, the score for VOD content changes to (5*1)+(10*0.1), or 6. In one implementation, each activity (e.g., renting, watching, bookmarking, purchasing, researching, etc. a title) may be associated with a different weight value. The weight values may reflect a predicted amount of interest, by the subscriber, in the title. For example, researching and bookmarking may be assigned relatively lowers weight than rentals and purchases.

Coupon generator 520 may apply one or more logical rules to determine whether to generate digital coupon 102 for the digital content type based on a corresponding score. For example, coupon generator 520 may generate digital coupon 102 for the digital content type if the corresponding score for the digital content type satisfies a threshold value. In another example, coupon generator 520 may generate digital coupon 102 for the digital content type if the corresponding score for the digital content type differs from a score for another digital content type by at least a threshold amount. In a third example, coupon generator 520 may generate digital coupon 102 for the digital content type if the corresponding score changes by at least a threshold amount between two time periods.

Coupon generator 520 may determine a discount amount associated with digital coupon 102 based on subscriber history 101. For example, digital coupon 102 may offer discounted access to a digital content type if the activity level (or score) satisfies a first threshold value, and may offer a free rental to a digital content type if the activity level (or score) satisfies a second, different threshold value. In another example, a discount amount associated with digital coupon 102 may be a fraction of the score for the digital content type and/or a difference between the score for the digital content type or the score for another digital content type.

In another example, if a subscriber requests a movie (or other digital content), coupon generator 520 may determine (e.g., by interfacing with data center 220), digital content type options associated with the movie. For example, coupon generator 520 may determine whether the movie is available via stream subscription channel, is a rentable VOD title, is a purchasable VOD title, is available via OTT content, is available for pickup from a kiosk, etc. In this example, coupon generator 520 may generate digital coupon 102 to encourage the subscriber to use a particular one of the available digital content types associated with the movie, such as to discount a digital content type that is least used by the particular subscriber during a time period preceding the request for the movie.

Although FIG. 5 shows exemplary functional components of coupon manager 205, in other implementations, coupon manager 205 may include fewer functional components, different functional components, differently arranged functional components, or additional functional components than those depicted in FIG. 5. Alternatively, or additionally, one or more functional components of coupon manager 205 may perform one or more other tasks described as being performed by one or more other functional components of coupon manager 205.

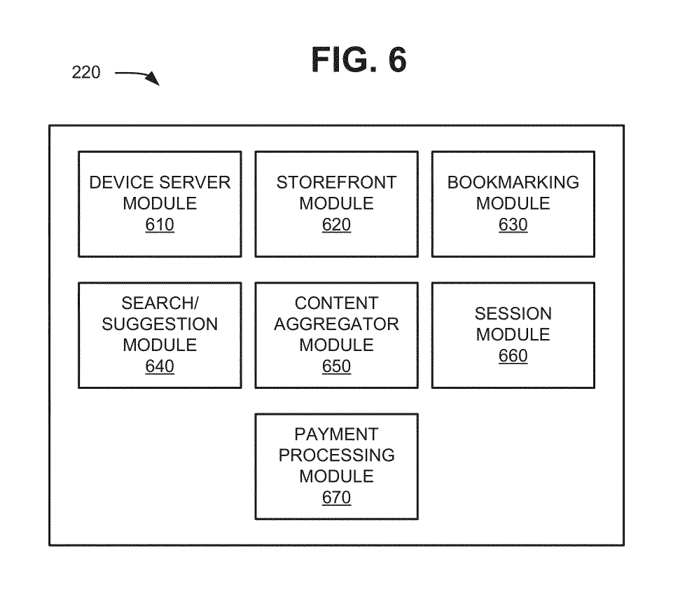

FIG. 6 is a diagram of exemplary functional components of data center 220. In one implementation, the functions described in connection with FIG. 6 may be performed by one or more components of device 300 (FIG. 3). As shown in FIG. 6, data center 220 may include a device server module 610, a storefront module 620, a bookmarking module 630, a search/suggestion module 640, a content aggregator module 650, a session module 660, and a payment processing module 670.

Device server module 610 supports interactions between user devices 270 and backend servers, including (but not limited to) coupon manager 205, catalog server 222, content delivery system 212, and DRM server 214. Device server module 610 may determine which content format to use according the device type or platform. Device server module 610 may also aggregate content from different servers according to a user devices 270 request. In one implementation, device server module 610 may also temporarily cache some content locally for performance purposes.

Storefront module 620 provides a subscriber interface to enable subscribers to review and select content in a variety of formats, including digital content and physical content. Storefront module 620 may support browsing and searching of the catalog (e.g., a catalog compiled by catalog server 222) from user devices 270. Storefront module 620 may also provide an electronic shopping cart, transaction management, and/or promotions and advertisements.

Bookmarking module 630 tracks subscriber viewing position (e.g., within particular digital content) and allows subscribers of user devices 270 to view the content from the most recently viewed position. In one implementation the most recently viewed portion may be based on the viewing from the same user device 270. In another implementation, the most recently viewed portion may be based on the subscriber account (e.g., regardless of the particular user device 270). For example, when a subscriber starts to view a video, bookmarking module 630 may ask a subscriber where to start the presentation (e.g., at the beginning or from where it was stopped during the previous viewing).

Search/suggestion module 640 provides a subscriber interface to enable a subscriber to search the catalog by keywords. Search/suggestion module 640 may recommend particular content to the subscriber based on the subscriber's search terms, profile, viewing history, or previously purchased content. Search/suggestion module 640 can also recommend physical assets based on the digital viewing history or personal preferences.

Content aggregator module 650 aggregates information from Internet searching and social networks related to particular content (e.g., a program or video) for a subscriber to view and share. In one implementation, content aggregator module 650 may provide links or other menu options to enable a subscriber to select related content provided by content aggregator module 650.

Session module 660 receives subscriber login information and forwards the subscriber login information to profile server 230 for validation. For example, session module may collect subscriber login information from user device 270 and forward the login information to profile server 230. Assuming the subscriber is authenticated (e.g., by profile server 230 or physical asset distribution system 250), session module 660 may receive a session token and send the session token to user device 270.

Payment processing module 670 may include an interface with billing server 260 to bill the customer for the transaction of a purchase, a rental or a subscription. In one implementation, payment processing module 670 may also include a credit exchange interface with physical asset distribution system 250 to enable the subscriber to use digital coupon 102 when acquiring physical media from physical asset distribution system 250 (e.g., from a kiosk). For example, when a subscriber purchases some digital content (e.g., via an STB), digital coupon 102, offering a credit for acquiring one or more physical media (e.g., DVDs or Blu-ray discs), may be deposited to a subscriber's account associated with physical asset distribution system 250.

Although FIG. 6 shows exemplary functional components of data center 220, in other implementations, data center 220 may include fewer functional components, different functional components, differently arranged functional components, or additional functional components than those depicted in FIG. 6. Alternatively, or additionally, one or more functional components of data center 220 may perform one or more other tasks described as being performed by one or more other functional components of data center 220.

FIG. 7 is a diagram of exemplary functional components of billing server 240. In one implementation, the functions described in connection with FIG. 7 may be performed by one or more components of device 300 (FIG. 3). As shown in FIG. 7, billing server 240 may include a billing processing module 710 and a settlements module 720.

Billing processing module 710 may perform processing to charge a subscriber's account after the subscriber accesses (e.g., buys, rents, or subscribes to) content listed in the video catalog. Billing processing module 710 may receive (e.g., from data center 220) a purchase or rental payment request and initiate a payment transaction via a payment gateway (e.g., credit card processing). When initiating the payment transfer, billing processing module 710 may apply a discount or other benefit associated with digital coupon 102 if digital coupon 102 is applicable to the subscriber's access. For example, billing processing module 710 may bill subscriptions to a subscriber's account automatically each month (or at another interval), and digital coupon 102 may reduce the subscription fee. Billing processing module 710 may synchronize the billing results with profile server 230 to enforce entitlement restrictions and may generate a report (e.g., either periodically for a group or transactions or for individual transactions) related to physical assets.

In one implementation, billing processing module 710 may also include an interface (not shown) with customer support system 260 to permit credit adjustments and/or cancellations related to charge disputes or to permit a customer service representative to apply a digital coupon 102 to a subscriber's account. For example, if the subscriber expresses dissatisfaction with service provider 100, the customer service representative may access coupon manager 205 to identify services/products that are underused by the subscriber and offer coupon 102 to the subscriber based on the identified services/products.

Settlements module 720 includes features to provide cost assurance and revenue assurance. Cost assurance assures that partners (such as a studio or another content source) are paid according to a previously agreed contract. In one implementation, settlements module 720 may modify the amount paid to the partners based on the terms associated with digital coupon 102. Contract information (e.g., for content sources) may be provided from a contract management source (not shown). Revenue assurance ensures that subscribers have paid a bill according to the subscriber's purchase, rental, or subscription agreement. In one implementation, settlements module 720 may receive a settlement file from VCMS 210 that identifies content provider settlements (e.g., how much revenue to share with particular studios) based on actual usage statistics. Settlements module 720 may also include an interface with individual content providers (not shown) to provide revenue accounting.

Although FIG. 7 shows exemplary functional components of billing server 240, in other implementations, billing server 240 may include fewer functional components, different functional components, differently arranged functional components, or additional functional components than those depicted in FIG. 7. Alternatively, or additionally, one or more functional components of billing server 240 may perform one or more other tasks described as being performed by one or more other functional components of billing server 240.

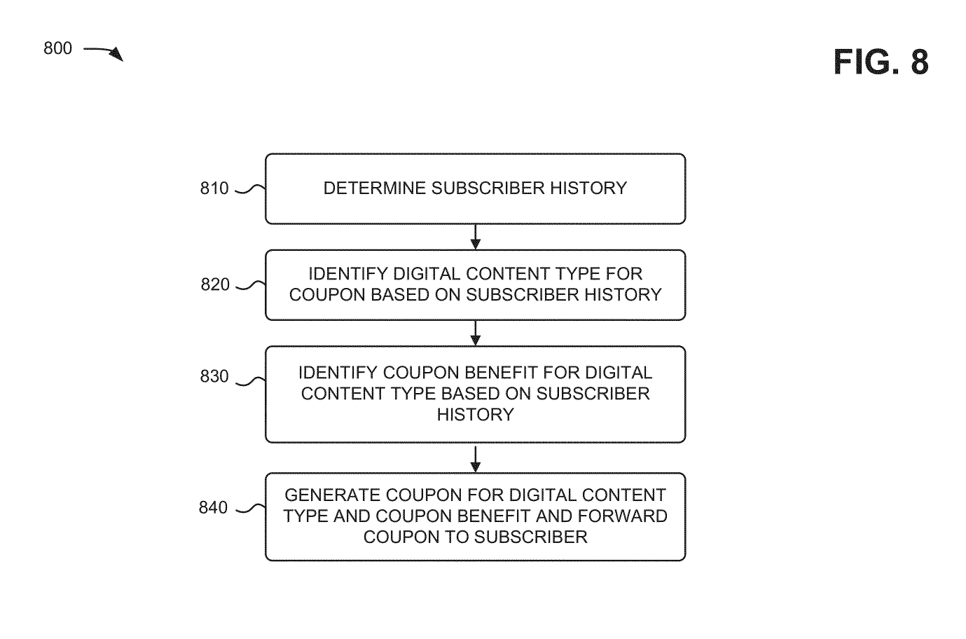

FIG. 8 is a flow chart of an exemplary process 800 for providing access to multi-screen video and physical asset orders according to an implementation described herein. Process 800 is described with respect to components in environment 200. In one implementation, process 800 may be performed by coupon manager 205. Alternatively, or additionally, some or all of process 800 may be performed by another device or group of devices, including or excluding coupon manager 205.

As shown in FIG. 8, process 800 may include obtaining subscriber history 101 (block 810). For example, coupon manager 205 may interface with data center 220 (e.g., via control data API 405) to obtain data regarding subscriber inputs received by user device 270. For example, coupon manager 205 may interface with data center 220 to identify digital content accessed (e.g., purchased or rented) by the subscriber, digital content bookmarked by the subscriber, digital content researched by the subscriber (e.g., by accessing portions of a catalog), and/or other actions performed by the subscriber. In another example, coupon manager 205 may directly interface with a user device 170, such as an STB, to determine the subscriber history 101.

Continuing with FIG. 8, process 800 may also include identifying a digital content type for digital coupon 102 based on subscriber history 101 (block 820). For example, subscriber history analyzer 510 may analyze subscriber history 101 to identify actions taken by the subscriber and types of digital content associated with the actions. For example, subscriber history analyzer 510 may identify VOD content purchased by the subscriber, VOD content rented by the subscriber, digital content items bookmarked by the subscriber, digital content viewed by the subscriber, physical media ordered by the subscriber through physical asset distribution 250, etc. In another example, subscriber history analyzer 510 may identify digital contents that a subscriber researched, such as identifying portions of a catalog (e.g., provided by VCMS 210) that are accessed by the subscriber, searches performed by the subscriber related to digital content, previews viewed by the subscriber, content reviews read by the subscriber, etc.

Coupon generator 520 may determine a digital content type (e.g., physical media, VOD rental content, VOD purchased content, OTT content, subscription content, etc.) to associate with digital coupon 102 based on purchases, bookmarks, research, and/or other aspects of subscriber history. In one example, if the subscriber's access of a first type of digital content does not satisfy a threshold quantity, coupon generator 520 may generate digital coupon 102 providing an incentive for accessing the first type of digital content. In this example, coupon generator 520 may further generate digital coupon 102 directed to the first type of digital content based on a comparison of the subscriber's activities, such as determining if the subscriber's access of a second, different type of digital content exceeds the threshold value. In another example, coupon generator 520 may generate digital coupon 102 directed to the first type of digital content if the subscriber performs actions suggesting an interest in the first type of digital content (e.g., bookmarking programs included in the first type of digital content, researching the programs included in the first type of digital content, and/or adding programs included in the first type of digital content to a shopping cart) without accessing the first type of digital content.

In block 820, coupon generator 520 may apply one or more logical rules to select a digital content type for digital coupon 102. For example, coupon generator 520 may generate digital coupon 102 for the digital content type if the subscriber performs at least a threshold quantity of actions related to the digital content type (e.g., the subscriber purchases/rents more than a threshold quantity of titles in the digital content type). In another example, coupon generator 520 may select a digital content type for digital coupon 102 if the subscriber's actions related to the digital content type differs from actions for another digital content type by at least a threshold amount (e.g., the subscriber accesses at least a threshold quantity more of titles in a first digital content type than titles in a second digital content type). In a further example, coupon generator 520 may generate digital coupon 102 for the digital content type if a quantity of actions related to the digital content type, performed the subscriber, changes by more than a threshold amount between two time periods (e.g., the subscriber accesses titles in the digital content type during a first time period at least a threshold quantity less than the subscriber accesses titles in the digital content type during a second time period).

In block 820, coupon generator 520 may select a digital content type based on additional factors. For example, coupon generator 520 may generate digital coupon 102 for the digital content type even if the subscriber performs less than a threshold quantity of actions related to the digital content type (e.g., the subscriber purchases/rents less than a threshold quantity of titles in the digital content type) if the subscriber expresses dissatisfaction with the digital content type and/or the service provider. In addition or alternatively, coupon generator 520 may also determine to generate digital coupon 102 for a digital content type if any technical or services concerns are identified with respect to the subscriber's access to the digital content type. For example, digital coupon 102 may allow the subscriber to access VOD content during an additional time if the subscriber does not access the VOD content during an initial time period.

In one implementation of block 820, coupon generator 520 may determine a score for a digital content type (e.g., physical media, VOD content, OTT content, or subscription content) based on the subscriber's activities, and may determine based on the score whether to generate a digital coupon for the digital content type. For example, the score may be based on the subscriber's purchases, bookmarking, researching, etc. of a digital content type.

During block 820, coupon generator 520 may apply one or more logical rules to determine whether to generate digital coupon 102 for the digital content type based on a corresponding score. For example, coupon generator 520 may generate digital coupon 102 for the digital content type if the corresponding score for the digital content type satisfies a threshold value. In another example, coupon generator 520 may generate digital coupon 102 for the digital content type if the corresponding score for the digital content type differs from a score for another digital content type by at least a threshold amount. In a third example, coupon generator 520 may generate digital coupon 102 for the digital content type if the corresponding score changes by at least a threshold amount between two time periods.

As shown in FIG. 8, process 800 may further include determining a coupon benefit for the digital content type based on subscriber history 101 (block 830). For example, coupon generator 520 may determine a discount amount associated with digital coupon 102 based on the subscriber's activities. For example, digital coupon 102 may offer discounted access to a digital content type if the activity level (or score) satisfies a first threshold value, and may offer a free rental to a digital content type if the activity level (or score) satisfies a second, different threshold value. In another example, a discount amount associated with digital coupon 102 may be a fraction of the score for the digital content type and/or a difference between the score for the digital content type or the score for another digital content type.

As shown in FIG. 8, process 800 may still further include causing digital coupon 102 to be forwarded to the subscriber (block 840). For example, coupon manager 205 may forward digital coupon 102 to user device 170 (such as an associated STB). In addition or alternatively, coupon manager 205 may forward digital coupon 102 to VCMS 210 to change pricing information identified in a catalog and/or to billing server 240 to adjust an associated fee if the subscriber orders media using the coupon. In another example, digital coupon 102 may be forwarded to a third party, such as an owner of a kiosk providing physical media, and digital coupon 102 may be applied by the third party.

Systems and/or methods described herein may provide digital coupon 102 to that which is generated based on a subscriber's activities. For example, digital coupon 102 may be directed to a type of digital content that is selected based on the subscriber's prior purchases and other activities, such as researching titles included in the digital content type, bookmarking titles included in the digital content type. The discount amount and/or other benefits associated with digital coupon 102 may also be determined based on the subscriber's prior purchases and other activities.

In the preceding specification, various preferred embodiments have been described with reference to the accompanying drawings. It will, however, be evident that various modifications and changes may be made thereto, and additional embodiments may be \implemented, without departing from the broader scope of the invention as set forth in the claims that follow. The specification and drawings are accordingly to be regarded in an illustrative rather than restrictive sense. For example, while series of blocks have been described with respect to FIG. 8, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Further, certain portions of the invention may be implemented as a “component” or “system” that performs one or more functions. These components/systems may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method comprising:
acquiring, by a processor, data regarding actions taken by a user with respect to a plurality of digital content types, wherein the actions include purchasing and bookmarking content from the plurality of digital content types;
selecting, by the processor, a particular digital content type from the plurality of digital content types based on the actions taken by the user;
determining, by the processor, a benefit associated with a particular digital content type based on the actions taken by the user;
generating, by the processor, a digital coupon, wherein the digital coupon enables the user to receive the benefit when acquiring content of the particular digital content type; and
providing, by the processor, the digital coupon to the user.

2. The method of claim 1, wherein selecting the particular digital content type includes:
determining scores for the plurality of digital content types based on the actions; and
selecting the particular digital content type from the plurality of digital content types based on the scores.

3. The method of claim 2, wherein selecting the particular digital content type from the plurality of digital content types based on the scores includes:
determining that a score for the particular digital content type satisfies a threshold value; and
selecting the particular digital content type for the digital coupon based on determining that the score for the particular digital content type satisfies the threshold value.

4. The method of claim 3, further comprising:
selecting the threshold value, wherein selecting the threshold value includes:
assigning, as the threshold value, a first value when the user request cancelation of a service providing the particular digital content type, and
assigning, as the threshold value, a second value that differs from the first value when the user is not requesting cancelation of the service.

5. The method of claim 2, wherein determining the benefit includes:
selecting a first benefit when a score for the particular digital content type satisfies a first threshold but does not satisfies a second threshold; and
selecting a second benefit when the score for the particular digital content type satisfies the second threshold.

6. The method of claim 2, wherein determining the scores for the plurality of digital content types includes:
assigning a first weight value to purchasing content from plurality of digital content types;
assigning a second weigh value to bookmarking content from plurality of digital content types, wherein the first and the second weight values differ; and
determining the scores for the plurality of digital content types based on quantities of purchasing and bookmarking identified in the data.

7. The method of claim 1, wherein providing the digital coupon to the user includes forwarding the digital coupon to a third-party distributing the physical media.

8. A device comprising:
a memory configured to store data regarding actions taken by a user with respect to a plurality of digital content types, wherein the actions include purchasing and bookmarking content from the plurality of digital content types; and
a processor configured to:
select a particular digital content type from the plurality of digital content types based on the actions taken by the user,
determine a benefit associated with a particular digital content type based on the actions taken by the user,
generate a digital coupon, wherein the digital coupon enables the user to receive the benefit when acquiring content of the particular digital content type, and
provide the digital coupon to the user.

9. The device of claim 8, wherein the processor, when selecting the particular digital content type, is further configured to:
determine scores for the plurality of digital content types based on the actions, and
select the particular digital content type from the plurality of digital content types based on the scores.

10. The device of claim 9, wherein the processor, when selecting the particular digital content type from the plurality of digital content types based on the scores, is further configured to:
determine that a score for the particular digital content type differs from a score for another digital content type by at least a threshold value, and
select the particular digital content type for the digital coupon based on determining that the score for the particular digital content type differs from the score for another digital content type by at least the threshold value.

11. The device of claim 9, wherein the processor, when determining the benefit, is further configured to:
select a first benefit when a score for the particular digital content type satisfies a first threshold but does not satisfies a second threshold, and
select a second benefit when the score for the particular digital content type satisfies the second threshold.

12. The device of claim 9, wherein the processor, when determining the scores for the plurality of digital content types, is further configured to:
assign a first weight value to purchasing content from plurality of digital content types,
assign a second weigh value to bookmarking content from plurality of digital content types, wherein the first and the second weight values differ, and
determine the scores for the plurality of digital content types based on quantities of purchasing and bookmarking identified in the data.

13. The device of claim 8, wherein the processor is further configured to:
receive, from the user, a request for a particular content, and
determine, as the plurality of digital content types, different delivery methods to provide the particular content to the user.

14. The device of claim 13, wherein the plurality of digital content types include a downloaded version of the particular content, a streamed version of the particular content, and a physical media version of the particular content, and
wherein the processor, when providing the digital coupon to the user, is further configured to forward the digital coupon to a third-party distributing the physical media version of the particular content.

15. A non-transitory computer-readable medium to store instructions comprising:
one or more instructions that, when executed by a processor, cause the processor to:
identify actions taken by a user with respect to a plurality of digital content types, wherein the actions include purchasing and bookmarking content from the plurality of digital content types,
select a particular digital content type from the plurality of digital content types based on the actions taken by the user,
determine a benefit associated with a particular digital content type based on the actions taken by the user,
generate a digital coupon, wherein the digital coupon enables the user to receive the benefit when acquiring content of the particular digital content type, and
provide the digital coupon to the user.

16. The non-transitory computer-readable medium of claim 15, wherein the one or more instructions further cause the processor, when selecting the particular digital content type, to:
determine scores for the plurality of digital content types based on the actions, and
select the particular digital content type from the plurality of digital content types based on the scores.

17. The non-transitory computer-readable medium of claim 16, wherein the one or more instructions further cause the processor, when selecting the particular digital content type from the plurality of digital content types based on the scores, to:
determine that a score for the particular digital content type changes by at least a threshold amount between two time periods, and
select the particular digital content type for the digital coupon based on the determining that the score for the particular digital content type changes by at least the threshold amount between the two time periods.

18. The non-transitory computer-readable medium of claim 16, wherein the one or more instructions further cause the processor, when determining the scores for the plurality of digital content types, to:
assign a first weight value to purchasing content from plurality of digital content types,
assign a second weigh value to bookmarking content from plurality of digital content types, wherein the first and the second weight values differ, and
determine the scores for the plurality of digital content types based on quantities of purchasing and bookmarking identified in the data.

19. The non-transitory computer-readable medium of claim 18, wherein the actions further include researching content from the plurality of digital content types in a catalog,
wherein the one or more instructions further cause the processor, when determining the scores for the plurality of digital content types, to:
assign a third weigh value to content from the plurality of digital content types in the catalog, and
wherein the third weight value differs from the first and the second weight values.

20. The non-transitory computer-readable medium of claim 15, wherein the processor is further configured to:
receive, from the user, a request for a particular content, and
determine, as the plurality of digital content types, different delivery methods to provide the particular content to the user.
